(19) United States
(12) Patent Application Publication
(10) Pub. No.: US 2012/0323385 A1
(43) Pub. Date: Dec. 20, 2012

(54) PROVIDING ENERGY MANAGEMENT RECOMMENDATIONS WITH AN ENERGY MANAGEMENT DEVICE

(75) Inventors: Hari Thiruvengada, Plymouth, MN (US); Pallavi Dharwada, Minneapolis, MN (US); Wendy Foslien, Woodbury, MN (US); Anand Tharanathan, Plymouth, MN (US)

(73) Assignee: Honeywell International Inc., Morristown, NJ (US)

(21) Appl. No.: 13/163,205

(22) Filed: Jun. 17, 2011

(51) Int. Cl. G06F 1/32

(52) U.S. Cl. 700/291

(57) ABSTRACT

Devices, systems, and methods for providing energy management recommendations are provided. One method includes recording a number of interactions between a user and a computing device, creating an energy usage profile according to the number of interactions between the user and the computing device, computing energy usage analytics associated with the energy usage profile, presenting the energy usage analytics to the user, and providing a number of energy management recommendations that account for the usage analytics and the energy usage profile.

### TECHNICAL FIELD

The present disclosure relates to providing energy management recommendations with a computing device.

### BACKGROUND

Energy conservation has become more of a concern in recent years as the depletion of natural resources has continued and the cost for natural resources has risen. The reduction of energy consumption can provide sectors (e.g., commercial, residential, governmental) with, for example, cost savings realized from a reduction in energy that is purchased. Reduced energy consumption can also help improve environmental quality by reducing emissions resulting from the use of natural resources (e.g., burning of natural gas).

Systems have been developed that provide generic recommendations to a user for reducing energy consumption based on static information. For example, these recommendations can be based on a size of a house (e.g. square footage). However, the amount of energy these recommendations can save is limited because the systems only consider static information when forming recommendations.

### BRIEF DESCRIPTION OF THE DRAWINGS

FIG. 1 illustrates a computing device for providing energy management recommendations according to one or more embodiments of the present disclosure.

FIG. 2 illustrates an example of a system for providing energy management recommendations according to one or more embodiments of the present disclosure.

FIG. 3 illustrates an example of a method for providing energy management recommendations according to one or more embodiments of the present disclosure.

### DETAILED DESCRIPTION

The present disclosure provides devices, systems, and methods for providing energy management recommendations. One or more embodiments include recording a number of interactions between a user and a computing device, creating an energy usage profile according to the number of interactions between the user and the computing device, computing energy usage analytics associated with the energy usage profile, presenting the energy usage analytics to the user, and providing a number of energy management recommendations that account for the usage analytics and the energy usage profile.

Embodiments of the present disclosure can decrease energy consumption associated with a structure (e.g., residential, commercial) by providing energy management recommendations to the user. As an example, the energy management recommendations can take into account energy usage analytics of a number of appliances and/or an energy usage profile in providing the user with a number of tailored recommendations for managing their energy usage.

In the following detailed description, reference is made to the accompanying drawings that form a part hereof. The drawings show by way of illustration how one or more embodiments of the disclosure may be practiced. These embodiments are described in sufficient detail to enable those of ordinary skill in the art to practice one or more embodiments of this disclosure. It is to be understood that other embodiments may be utilized and that process, electrical, and/or structural changes may be made without departing from the scope of the present disclosure.

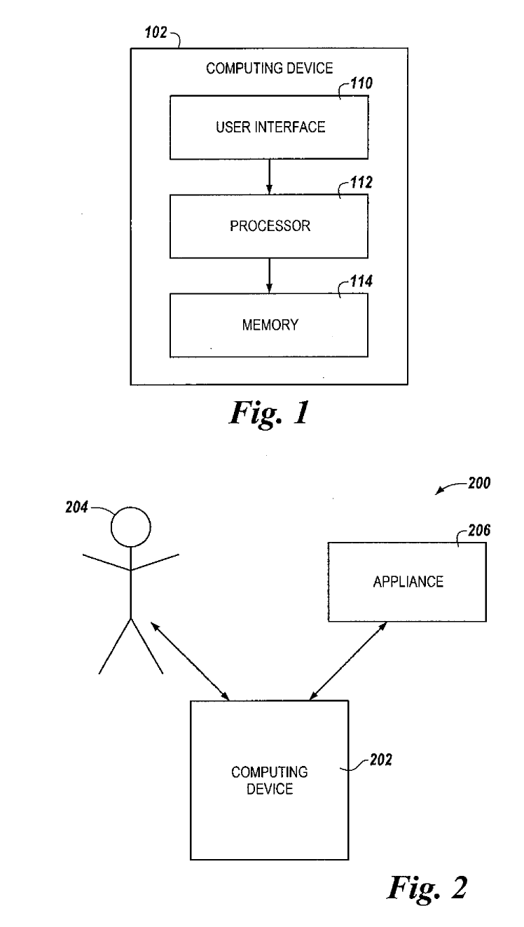

The figures herein follow a numbering convention in which the first digit or digits correspond to the drawing figure number and the remaining digits identify an element or component in the drawing. Similar elements or components between different figures may be identified by the use of similar digits. For example, 102 may reference element “02” in FIG. 1, and a similar element may be referenced as 202 in FIG. 2.

As will be appreciated, elements shown in the various embodiments herein can be added, exchanged, combined, and/or eliminated so as to provide a number of additional embodiments of the present disclosure. The proportion and the relative scale of the elements provided in the figures are intended to illustrate the embodiments of the present disclosure, and should not be taken in a limiting sense.

As used herein, “a” or “a number of” something can refer to one or more such things. For example, “a number of programmed set points” can refer to one or more programmed set points.

FIG. 1 illustrates a computing device 102 for providing energy management recommendations according to one or more embodiments of the present disclosure. The computing device 102 can be, for example, a thermostat, a desktop computing device, a laptop computing device, or a portable handheld computing device, such as, for instance, a portable handheld mobile phone, media player, or scanner. However, embodiments of the present disclosure are not limited to a particular type of computing device. Additionally, computing device 102 can be an energy management device that is part of an energy management system.

As shown in FIG. 1, computing device 102 includes a user interface 110. User interface 110 can be a graphic user interface (GUI) that can provide (e.g., display and/or present) and/or receive information (e.g., data and/or images) to and/or from the user (e.g., operator) of computing device 102. For example, user interface 110 can include a screen that can provide information to the user of computing device 102 and/or receive information entered into a display on the screen (e.g., touch screen) by the user. However, embodiments of the present disclosure are not limited to a particular type of user interface.

In an example, the user interface 110 can include two levels of displays for energy management. A level 1 display can include an overview display showing all schedules for all appliances and a level 2 display can be a detailed display for a particular appliance.

The level 1 display can indicate a total cost associated with operating a number of appliances. Alternatively, and/or in addition, the level 1 display can indicate a scheduled start and/or end time, run duration, and/or energy usage for the number of appliances. This information can be broken down into price tiers (e.g., peak electrical rates, off peak electrical rates, etc.) and can be segregated by each price tier. In an example, the user can sort appliances based on cost, energy usage, scheduled run duration, and/or price tiers, although examples are not so limited. Energy management recommendations for reducing energy usage associated with the number of appliances can also be provided on the level 1 display.

The level 1 display can be divided into user selectable regions (e.g., appliances, cost, energy). Upon selection by the user of a region of level 1, a level 2 display can be displayed, which can provide a detailed display of the selected region of level 1. The level 2 display can include a display that allows the user to review and/or modify a schedule for an appliance, for example. Upon modification of parameters such as cost, start and/or end time, run duration, and/or energy usage, these parameters are automatically recalculated and displayed.

The user can also add a new appliance schedule on the level 2 display by, for example, dragging and dropping an appliance icon from an appliance palette. The appliance palette can include an area on the display that includes a number of appliance icons that are user selectable. The level 2 display can also provide information on an appliance schedule and/or other settings associated with the appliance (e.g., what temperature an appliance is set to maintain) when the user selects the schedule for the appliance on the level 2 display. Further an energy management and/or cost savings recommendation for the specific appliance can be displayed based on an appliance type. For example, a recommendation to increase the temperature a refrigerator and/or freezer is set at can be displayed. Although features of the level 1 and level 2 display are discussed separately, features of level 1 and/or level 2 can be combined into one or more levels.

As shown in FIG. 1, computing device 102 includes a processor 112 and a memory 114. Memory 114 can be coupled to processor 112. Memory 114 can be volatile or nonvolatile memory. Memory 114 can also be removable (e.g., portable) memory, or non-removable (e.g., internal) memory. For example, memory 114 can be random access memory (RAM) (e.g., dynamic random access memory (DRAM) and/or phase change random access memory (PCRAM)), read-only memory (ROM) (e.g., electrically erasable programmable read-only memory (EEPROM) and/or compact-disk read-only memory (CD-ROM)), flash memory, a laser disk, a digital versatile disk (DVD) or other optical disk storage, and/or a magnetic medium such as magnetic cassettes, tapes, or disks, among other types of memory.

Further, although memory 114 is illustrated as being located in computing device 102, embodiments of the present disclosure are not so limited. For example, memory 114 can also be located internal to another computing resource (e.g., enabling computer readable instructions to be downloaded over the Internet or another wired or wireless connection).

In some embodiments, memory 114 can store data associated with the user's energy usage profile. Memory 114 can also store executable instructions, such as, for example, computer readable instructions (e.g., software), for providing energy management recommendations in accordance with one or more embodiments of the present disclosure.

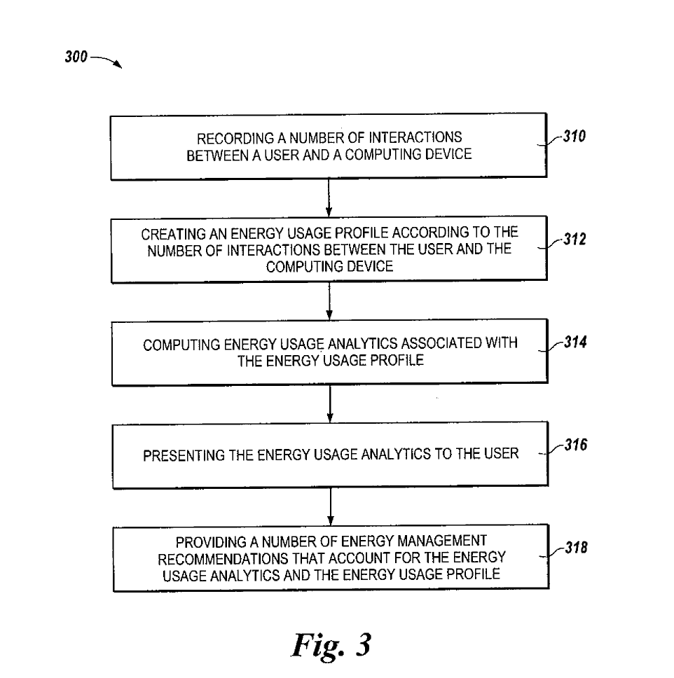

Processor 112 can execute the executable instructions stored in memory 114 to provide energy management recommendations in accordance with one or more embodiments of the present disclosure. For example, processor 112 can execute the executable instructions stored in memory 114 to perform one or more of the methods for providing energy management recommendations further described herein (e.g., in connection with FIG. 3).

Computing device 102 can record a number of interactions between the user and the computing device. In an example, the number of interactions can be associated with programming a number of appliances through the computing device. Programming the number of appliances can include, for example, setting a schedule for when an appliance is to run (e.g., pool pump) and/or adjusting settings of an appliance (e.g., a temperature that an area is to be held at by a furnace and/or air conditioning unit), although examples are not so limited. An appliance can include any device and/or instrument designed for a particular use (e.g., dishwasher, pool pump, furnace, water heater, light bulb).

When the user programs the number of appliances through the computing device 102, the user can interact with the user interface 110. Interactions can include any prompt that the user makes through the user interface 110.

Alternatively, and/or in addition, interactions can include spoken commands that the user makes when programming an appliance, which can be recognized by a voice command system that can optionally be incorporated into the computing device 102.

Interactions can also include the user accepting or denying a recommendation provided by the computing device 102. The computing device 102 may provide a recommendation to the user on how to manage energy usage (e.g., conserve energy). The user's interaction with the computing device 102 regarding the recommendation (e.g., the user accepting or denying the recommendation) can be recorded by the computing device 102.

The computing device 102 can create an energy usage profile according to the number of interactions between the user and the computing device 102. Based on the recorded interactions, as discussed herein, the computing device 102 can store user preferences associated with the recorded interactions in the energy usage profile. Accordingly, energy management recommendations may be tailored to an individual user based upon previous responses that were obtained from the user by the computing device 102. For example, if the user has consistently accepted energy management recommendations that conserve energy, the computing device 102 may provide a prompt to the individual indicating that the computing device 102 has created an energy usage profile for the user. The user can be given an option of selecting the energy usage profile and/or the computing device can automatically select the custom energy profile for the user.

The computing device 102 may also provide a survey that presents questions to the user that will assess the user's energy management principles in accordance with the answers provided by the user. Based on the user's answers to the questions, the computing device 102 can associate a particular energy usage profile with the user. In an example, the computing device 102 can include a miser energy usage profile and/or a non-miser energy usage profile. If the miser energy usage profile is associated with the user, check boxes associated with energy management recommendations can come up as checked by default. If the non-miser energy usage profile is associated with the user, energy management recommendations can come up as unchecked, but recommended by the computing device 102.

Alternatively, and/or in addition, the computing device can include a number of energy usage profiles between the miser and non-miser energy usage profile, wherein a portion of the check boxes associated with the energy management recommendations can be checked and/or unchecked by default. In some embodiments, when the energy usage profile is associated with the user, the computing device can give the user an option of selecting the energy usage profile, as discussed herein.

In some embodiments, the computing device 102 can compute energy usage analytics associated with the energy usage profile and each of the number of appliances. Energy usage analytics can include an amount of energy that is consumed (e.g., kilowatt hours) by the number of appliances and/or a cost of the amount of energy that is consumed by the number of appliances. Upon selection of the energy usage profile by the user and/or computing device 102, schedules (e.g., how long an appliance operates for) and/or settings (e.g., what temperature an appliance is set to maintain) can be set, although examples are not so limited. Based on what energy usage profile is selected, the computing device 102 can determine the total amount of energy usage associated with the profile. Alternatively, and/or in addition, computing device 102 can also determine the total amount of energy usage associated with each of the number of appliances.

In various embodiments, the computing device 102 can compute expected energy usage associated with the energy usage profile and/or each of the number of appliances. The computing device 102 can do so by using historical information acquired by the computing device 102, which can include past energy usage (e.g., within the past week, month, year, and/or 5 years) associated with the structure where the computing device 102 is mounted.

Upon computation of the energy usage analytics, the computing device 102 can present the energy usage analytics to the user. The energy usage analytics can be presented to the user in the form of a line graph, bar graph, pie chart, and/or numerical values.

The computing device 102 can further display an energy usage budget that is selected by the user and/or the computing device 102. The energy usage analytics can be compared to the energy usage budget in the form of past, present, and/or future energy usage and variations from the energy usage budget can be displayed.

In some embodiments, the computing device 102 can provide a number of energy management recommendations for reducing a current energy usage, wherein the recommendations account for the energy usage analytics and the energy usage profile. As discussed herein, the energy management recommendations can be tailored to the energy usage profile of the user. Therefore, if the user's profile indicates that in past decisions related to energy usage, the user has chosen to keep their hot tub heated to 110 degrees Fahrenheit year round; the computing device can avoid making a recommendation to turn down the temperature and/or to heat the hot tub periodically, for example.

The computing device 102 can be configured to detect a malfunction in the number of appliances and provide a recommendation for correcting the malfunction in the number of appliances. In an example, a number of pressure sensors in wired and/or wireless communication with the computing device 102 can be installed in an air duct in a furnace before and/or after a furnace air filter. Data can be collected from the sensors to determine a baseline pressure differential between the number of sensors with a new furnace air filter installed. Upon a change in the pressure differential between the sensors, the computing device 102 can indicate that the furnace air filter is dirty and provide a recommendation that the filter should be changed.

Alternatively, and/or in addition, a number of temperature sensors in communication with the computing device 102 can be installed in an appliance that has heating and/or cooling elements to detect a malfunction. In an example, upon startup of the appliance, a baseline measurement associated with a pre-heat and/or pre-cool ramp up period can be recorded by the computing device 102. The pre-heat ramp up period can be defined as the time that an appliance takes to heat to a predetermined temperature. In contrast, the pre-cool ramp up period can be defined as the time that an appliance takes to cool to a predetermined temperature.

The computing device 102 can monitor the pre-heat and/or pre-cool ramp up periods for a change (e.g., the pre-heat and/or pre-cool ramp up periods are taking longer than normal). If a change is detected, the computing device 102 can indicate that there is a possible malfunction associated with a heating and/or cooling element and/or a faulty schedule and provide a recommendation on how to correct the malfunction (e.g., reset or restore the schedule, replace the heating and/or cooling elements, schedule maintenance by calling a dealer at a telephone number provided by the computing device if the problem persists).

In various embodiments, the computing device 102 can be configured to create a list of maintenance items associated with the appliances (e.g., replacement furnace air filter, heating and/or cooling element) for the user to purchase. The computing device 102 can further be configured to provide the list on the user interface 110, the user's mobile telephone, a smart reader, a web portal, a utility bill, an email to the user, and/or a social network media update. Alternatively, and/or in addition, the computing device 102 can order a number of the maintenance items for the user through an internet connection.

FIG. 2 illustrates a system 200 for providing energy management recommendations according to one or more embodiments of the present disclosure. The system 200 includes a computing device 202, a user 204, and a number of appliances 206. The computing device 202 can determine a user profile based on user interactions with the computing device 202.

In various embodiments, data retrieved from a social networking site can be used in creating the energy usage profile. In such an example, the computing device 202 can communicate and/or receive information from the social networking site (e.g., Facebook, Twitter). The information gathered from the site can then be used to create the energy usage profile for the user. In an example, a number of pages that the user “likes” on Facebook can be evaluated to determine characteristics of the user 204 (e.g., whether the user is concerned about the environment, whether the user is interested in conserving energy, and/or whether the user is comfort minded) to determine the user's 204 energy usage profile. Alternatively, and/or in addition, Facebook messages can be evaluated to determine the same, although examples are not so limited.

In an example, the computing device 202 can provide a comparison of the energy usage analytics associated with the user 204 to a social sample (e.g., a group of individuals), wherein the social sample is taken from the social networking site. By providing the user 204 with the amount of energy they are consuming in relation to the social sample, the user 204 can evaluate their energy conservation efforts in relation to others. If the user 204 is using more energy than those in the social sample, it may provide motivation for the user 204 to reduce their energy consumption to more align with the efforts of others in the social sample.

In determining who is included in the social sample, the computing device 202 may evaluate demographics (e.g., location, age, race, income, home ownership, employment status) of individuals on the social networking site. In an example, a social sample with similar demographics to the user can then be chosen. Alternatively, and/or in addition, a social sample of a general population may be obtained by the computing device 202.

Computing device 202 can communicate and/or receive this information via a network, such as, for example, a wide area network (WAN) such as the Internet, a local area network (LAN), a personal area network (PAN), a campus area network (CAN), or metropolitan area network (MAN), among other types of networks.

As used herein, a “network” can provide a communication system that directly or indirectly links two or more devices (e.g., computing devices and/or peripheral devices) and allows users to access resources on other devices and exchange messages with other users. A network can allow users to share resources on their own devices with other network users and to access information on centrally located devices or on devices that are located at remote locations.

A network may provide connections to the Internet and/or to the networks of other entities (e.g., organizations, institutions, etc.). Users may interact with network-enabled software applications to make a network request, such as to get a file from other network resources. For instance, applications may communicate with network management software, which can interact with network hardware to transmit information between networked devices.

Alternatively, and/or in addition, computing device 202 can provide energy management recommendations to the user 204 based on energy management recommendations chosen by a number of other users. In some embodiments, when a user chooses to use an energy management recommendation, the computing device 202 can provide a number of other energy management recommendations to the user that were chosen by the number of other users who also chose to use the energy management recommendation chosen by the user. In an example, the computing device 202 may indicate that users who used energy management recommendation A also used energy management recommendations B, C, D, and E to reduce energy usage. Patterns of what energy management recommendations users chose to use can be derived from the social networking site and/or a database that tips are stored in.

In various embodiments, the energy management recommendations chosen by the number of other uses can be displayed when the energy management recommendations apply to the user and not displayed when the energy management recommendations do not apply to the user. For example, if an indication has been provided to the computing device 202 that the user 204 does not have a pool, the computing device 202 can be configured to not display an energy management recommendation that has been chosen by a number of other users to schedule a pool pump.

In some embodiments, the computing device 202 can calculate current energy usage analytics associated with the user profile. Current energy usage analytics can include an amount of energy that is being consumed by the number of appliances at current settings associated with the number of appliances. Current energy usage analytics can also include a cost of the amount of energy that is being consumed by the number of appliances at current settings associated with the number of appliances. Settings can include a schedule of a number of appliances and/or a temperature that a number of appliances are set to operate at, although examples are not so limited. Upon calculation of the current energy usage analytics, the computing device 202 can display the current usage analytics to the user 204.

The computing device 202 can provide an energy management recommendation to the user 204, wherein the energy management recommendation includes a recommendation to adjust a number of schedules of the number of appliances. The computing device 202 may recommend that the schedules of the number of appliances be adjusted because a plurality of appliances are scheduled to run at the same time. In such a case, the computing device 202 can be configured to provide a notification that the plurality of appliances are scheduled to run during the same time. In an example, the user 204 may wish to adjust the schedule of the plurality of appliances running simultaneously to reduce peak load during peak electrical rates, prolong appliance life, and/or avoid tripping an electrical circuit due to an electrical overload.

The computing device 202 can query the user 204 if they would like help with automatically scheduling the number of appliances using a recommended schedule setting provided by the computing device 202. If the user 204 responds that they would like help with scheduling, then the computing device 202 can pick the recommended schedule setting based on the user's profile and appliance characteristics (e.g., electrical current draw). In an embodiment, the computing device 202 can display an energy usage for a current schedule setting and the recommended schedule setting. This may help the user 204 decide if switching to the recommended schedule setting is worthwhile.

FIG. 3 illustrates a computer implemented method 300 for providing energy management recommendations according to the present disclosure. The method includes recording a number of interactions between a user and a computing device at block 310. The method, at block 312, includes creating an energy usage profile according to the number of interactions between the user and the computing device. At block 314, the method includes computing energy usage analytics associated with the energy usage profile.

The method includes presenting the energy usage analytics to the user at block 316. In an example, presenting the energy usage analytics to the user can include presenting the energy usage analytics for a number of appliances. In such an example, the energy usage analytics can be presented for each of the number of appliances separately and/or the energy usage analytics can be presented for each of the number of appliances in sum.

The method, at block 318, includes providing a number of energy management recommendations that account for the usage analytics and the energy usage profile. In an example, expected energy usage analytics can be provided for an energy management recommendation associated with the number of appliances. Accordingly, the user can be presented with the amount of energy that will be used by the energy management recommendation. As such, the user can determine how much energy the recommendation will save.

In various embodiments, the energy management recommendation can be provided through the computing device. Alternatively, and/or in addition, the energy management recommendations can be provided through a mobile telephone, a smart reader, a web portal, a utility bill, an email to the user, and/or a social network media update.

The energy management recommendations can include ways to reduce current energy usage. In an example, ways to reduce current energy usage can include adjusting the schedule of an appliance (e.g., reducing a time that an appliance runs for), performing maintenance on the number of appliances (e.g., replacing a furnace filter), and/or upgrading an appliance. Alternatively, and/or in addition, the recommendations may provide a notification of a number of reasons for the user to follow the energy management recommendations. Such reasons can include notifying the user of an amount that energy usage will be reduced and/or cost savings provided by following the recommendation.

In various embodiments, the method can include providing an alert to the user, wherein the alert is based on an energy management event associated with the number of appliances. In an example, the alert may be provided to the user to notify the user that a refrigerator door is open, a default temperature inside a freezer and/or fridge is too low and/or high, and/or an appliance is exceeding a default electrical current draw, although examples are not so limited.

The alert regarding the energy management event associated with the number of appliances can also be used for detecting an occupancy of a structure where the computing device is mounted. In an example, a sensor may be placed on a door of an appliance (e.g., a refrigerator door). Upon an opening and/or closing of the door, the sensor can send a signal to the computing device, providing an indication that the structure is occupied. Using this information, the computing device can determine a schedule for the number of appliances. For example, if the computing device determines that no one is occupying the structure, the computing device can turn off appliances that are not being used and/or schedule the appliances in a manner that reduces energy consumption.

Other methods can also be used for occupancy detection. In an example, the computing device can measure an energy usage associated with the number of appliances. The computing device can establish a baseline energy usage associated with the number of appliances. The baseline energy usage associated with the number of appliances can be a sum of the energy usage associated with all and/or some of the number of appliances. Alternatively, and/or in addition, the baseline energy usage associated with the number of appliances can be the energy usage associated with a single appliance (e.g., a light bulb, dishwasher).

The computing device can be configured to detect a variation of the baseline energy usage and to indicate occupancy of the structure and/or parts of the structure based on the variation of the baseline energy usage in the entire structure and/or individual rooms of the structure. For example, if all the occupants of the structure are gone, the energy usage for the number of appliances may drop below the baseline energy usage. If only some of the occupants of the structure are gone, the energy usage associated with individual rooms and/or appliances may drop below a baseline energy usage. Accordingly, the computing device can determine the occupancy of the structure and/or individual rooms based on how much the energy usage varies from the baseline energy usage. As such, the computing device can turn off appliances that are not being used and/or schedule the appliances associated with the structure and/or individual rooms in a manner that reduces energy consumption (e.g., reduce heat flow to the structure and/or individual rooms).

Although specific embodiments have been illustrated and described herein, those of ordinary skill in the art will appreciate that an arrangement calculated to achieve the same results can be substituted for the specific embodiments shown. This disclosure is intended to cover adaptations or variations of various embodiments of the present disclosure. It is to be understood that the above description has been made in an illustrative fashion, and not a restrictive one. Combination of the above embodiments, and other embodiments not specifically described herein will be apparent to those of skill in the art upon reviewing the above description.

The scope of the various embodiments of the present disclosure includes other applications in which the above structures and methods are used. Therefore, the scope of various embodiments of the present disclosure should be determined with reference to the appended claims, along with the full range of equivalents to which such claims are entitled.

In the foregoing Detailed Description, various features are grouped together in a single embodiment for the purpose of streamlining the disclosure. This method of disclosure is not to be interpreted as reflecting an intention that the disclosed embodiments of the present disclosure have to use more features than are expressly recited in each claim.

Rather, as the following claims reflect, inventive subject matter lies in less than all features of a single disclosed embodiment. Thus, the following claims are hereby incorporated into the Detailed Description, with each claim standing on its own as a separate embodiment.

What is claimed:

1. A computer implemented method for providing energy management recommendations, the method comprising:
recording a number of interactions between a user and a computing device;
creating an energy usage profile according to the number of interactions between the user and the computing device;
computing energy usage analytics associated with the energy usage profile;
presenting the energy usage analytics to the user; and
providing a number of energy management recommendations that account for the usage analytics and the energy usage profile.

2. The computer implemented method of claim 1, wherein presenting the energy usage analytics to the user includes presenting the energy usage analytics for a number of appliances.

3. The computer implemented method of claim 2, wherein providing a number of energy management recommendations includes providing expected energy usage analytics for an energy management recommendation associated with the number of appliances.

4. The computer implemented method of claim 1, wherein providing the energy management recommendations includes providing the energy management recommendations through at least one of the computing device, a mobile telephone, a smart reader, a web portal, a utility bill, an email to the user, or a social network media update.

5. The computer implemented method of claim 1, wherein providing the number of energy management recommendations that account for the usage analytics includes providing a number of energy management recommendations that include ways to reduce the current energy usage.

6. The computer implemented method of claim 1, wherein providing the number of energy management recommendations further includes providing a notification of a number of reasons for a user to follow the number of energy management recommendations.

7. The computer implemented method of claim 6, wherein providing the notification of the number of reasons includes notifying the user of an amount that energy usage will be reduced.

8. The computer implemented method of claim 1, wherein creating the energy usage profile according to the number of interactions between the user and the computing device includes creating the energy usage profile according to data retrieved from a social networking site.

9. The computer implemented method of claim 1, wherein providing the number of energy management recommendations includes providing a number of other energy management recommendations to the user that were chosen by a number of other users who chose to use an energy management recommendation chosen by the user.

10. The computer implemented method of claim 1, wherein the method includes providing an alert to the user, wherein the alert is based on an energy management event associated with the number of appliances.

11. A computing device for providing energy management recommendations, comprising:
a memory; and
a processor configured to execute executable instructions stored in the memory to;
record a number of interactions between a user and the computing device, wherein the number of interactions are associated with programming a number of appliances through the computing device;
create an energy usage profile according to the number of interactions between the user and the computing device;
compute energy usage analytics associated with the energy usage profile and each of the number of appliances;
present the energy usage analytics to the user; and
provide a number of energy management recommendations for reducing a current energy usage, wherein the recommendations account for the energy usage analytics and the energy usage profile.

12. The computing device of claim 11, wherein the computing device is configured to display an energy usage budget and a variation from the current energy usage and the energy usage budget.

13. The computing device of claim 11, wherein the computing device is configured to detect a malfunction in the number of appliances.

14. The computing device of claim 13, wherein the computing device is configured to provide a recommendation for correcting the malfunction in the number of appliances.

15. The computing device of claim 13, wherein the computing device is configured to create a list of maintenance items associated with the appliances for a user to purchase.

16. The computing device of claim 11, wherein the computing device is configured to display a cost associated with the energy usage analytics.

17. A system for providing energy management recommendations, comprising:
a machine including processor resources; and
memory resources associated with the machine, the memory resources storing machine readable instructions that, when executed by the processor resources, cause the processor resources to:
determine a user profile based on user interactions with a computing device;
calculate current energy usage analytics associated with the user profile;
display the current energy usage analytics to the user; and
provide an energy management recommendation to the user, wherein the energy management recommendation includes a recommendation to adjust a number of schedules of the number of appliances.

18. The system of claim 17, wherein the machine readable instructions that cause the processor resources to provide the energy management recommendation to the user include machine readable instructions that cause the processor resources to provide a notification when a plurality of appliances are scheduled to run during a same time.

19. The system of claim 17, wherein the machine readable instructions that cause the processor resources to provide the energy management recommendation to the user include machine readable instructions that cause the processor resources to provide a recommended schedule setting for the number of appliances.

20. The system of claim 19, wherein the machine readable instructions that cause the processor resources to display the current energy usage analytics to the user include machine readable instructions that cause the processor resources to display an energy usage for a current schedule setting and the recommended schedule setting.
